(19) United States
(12) Patent Application Publication
(10) Pub. No.: US 2019/0261811 A1
(43) Pub. Date: Aug. 29, 2019

(54) Silicone Coating For Baking Surface

(71) Applicant: Arlington Farms, LLC, Cleveland Heights, OH (US)

(72) Inventors: Roger Breedlove, Cleveland Heights, OH (US); Peter Jacobson, Cleveland Heights, OH (US)

(21) Appl. No.: 16/285,633

(22) Filed: Feb. 26, 2019

Related U.S. Application Data
(60) Provisional application No. 62/635,828, filed on Feb. 27, 2018.

(51) Int. Cl. A47J 36/02; A23L 5/10; B05D 5/08

(52) U.S. Cl. CPC A47J 36/025; A23V 2002/00; B05D 5/08; A23L 5/15

(57) ABSTRACT

A cooking utensil that includes a non-stick release agent that is mechanically secured to a substrate of the cooking utensil. The invention also pertains to a method for using the cooking utensil to heat and/or bake food products, and to a method for recoating the non-stick release agent on the substrate of the cooking utensil.

The present invention claims priority on U.S. Provisional Application Ser. No. 62/635,828 filed Feb. 27, 2018, which is incorporated herein by reference.

The present invention relates generally to cooking utensils, more particularly to cooking utensils having a non-stick cooking surface, more particularly to a cooking surface having a silicone surface, and even more particularly to a cooking surface having a silicone surface mechanically connected thereto, and a method of making the same.

### BACKGROUND OF THE INVENTION

Release of baked goods from the surfaces they are baked on or in is an important element in commercial baking. Failure to achieve quick and complete release of the food product from the baking surface can damage the baked food product, damage the cooking surface, and/or render the baking process cost-inefficient. Various release agents have been formulated to provide a quick and complete release of baked goods from such surfaces.

Most current non-stick cooking surfaces are typically made from a polytetrafluoride ethylene (PTFE) material such as, for example, Teflon®. However, these PTFE-coated surfaces are particularly susceptible to damage by scratching or flaking off when other cooking utensils come into contact with the PTFE-coated surface. Accordingly, plastic and/or non-metal cooking utensils must often be used in conjunction with PTFE-coated cooking surfaces so as to prevent damage of the coated surface. However, even with the use of plastic and/or non-metal cooking utensils, the PTFE-coated cooking surfaces still become damaged over time. Further, there are significant health risks associated with peeling PTFE coatings.

In continuous baking operations, the application of release agents has been used to facilitate in the release of a baked product from a baking surface. The use of release agents can be problematic as continuous application of the release agent between cleaning cycles can cause buildups of the release agent, thereby adversely affecting the quality of the baked goods and the efficiency of the baking operation. Permanent release surfaces, such as Teflon®, address these issues but have relatively short lives due to continuous heating and/or cooling cycles causing the release surface to fail as it separates and/or wears off from the underlying substrate.

Another type of release agent that has been used on baking surfaces is silicone. Current applications of silicone in baking products include: 1) the application of thin silicone sheets (some of which optionally comprise enclosed reinforcement structures) which are placed flat on cooking surfaces, 2) the application of thin coatings of silicone sprayed (typically resins) and/or dipped onto baking trays or pans (Bundy Pans), and 3) baking trays or pans formed from 100% silicone (typically elastomeric silicone). Thicker silicone coatings can be used to increase the life of the silicone coating; however, silicone is an effective insulator and thicker cross-sections of silicone limit heat transfer from the heat source onto the baking surface, thus potentially adversely affecting the proper baking of a food product and/or increasing the time required to bake the food product. Baking surfaces that are coated with thin coatings of silicone (typically resin spray coatings) have a short usable life due to the tendency of the silicone to separate and/or wears off from the substrate. Generally, to promote heat transfer, silicone coatings are designed to maintain close surface-to-surface contact between the substrate and the silicone. However, due to the different heat expansion coefficients of the silicone and the substrate that includes the silicone coating, the silicone is caused to eventually release from the substrate surface after several baking cycles.

Silicone coating have also been applied to perforated baking sheets and belts by dipping such sheets and belts in silicone. However, such a process is limited to cooking surfaces that include perforations and can be completely coated by a silicone coating. These silicone resin spray-coated or dipped baking utensils also suffer from rapid surface deterioration and wear.

Non-limiting examples of prior art coatings applied to cooking surfaces are discussed in United States Patent Publications Nos. 2006/0102013 (Huang) and 2003/0047838 (Beale), and U.S. Pat. No. 5,447,803 (Nagaoka et al.) and U.S. Pat. No. 7,488,515 (Groll).

In view of the current state of the prior art with regard to non-stick or reduced-stick baking surfaces, there is a need for a release agent such as a silicone which can be mechanically connected to a baking surface (e.g., cooking utensil) to increase the life of the baking surface and which baking surface does not impair the heat transfer between the coated substrate and the food product that is in contract with the non-stick or reduced-stick baking surfaces on the substrate surface.

### SUMMARY OF THE INVENTION

The present invention is directed to cooking utensils having a non-stick release agent. In particular, the present invention is directed to cooking utensils such as a baking pan or grill having a non-stick release agent such as a mechanically connected silicone coating on the food surface of the cooking utensil (e.g., cooking surface, heating surface, baking surface, food contact surface, etc.). In one specific non-limiting arrangement, the present invention is directed to a cooking utensil formed of a substrate (e.g., metal, plastic, wood, ceramic, glass, etc.) that has a silicone coating mechanically connected to one or more surfaces of the substrate, and typically releasably mechanically connected to the one or more surfaces of the substrate. For cooking utensil that are used to cook, bake or heat a food product, the substrate is typically formed of a high heat conducting material (e.g., metal, iron, aluminum, etc.); however, this is not required. The non-stick release agent can be applied to the food surface of various types of cooking utensils including, but not limited to, frying pans, stock pots, griddle plates, waffle irons, pots, pans, cookie sheets, baking sheets, muffin pans, cake molds, etc. In one non-limiting aspect of the present invention, the non-stick release agent is a silicone layer or coating. The means by which the non-stick release agent can be applied to the food surface of the cooking utensil is non-limiting. In one non-limiting configuration, the non-stick release agent is applied via spray coating; however, this is not required. As can be appreciated, the coating can be applied by other or alternative methods (e.g., dip coating, spray coating, brush coating, vapor deposition, compression molding, extrusion, injection molding, etc.). As can also be appreciated, the non-stick release layer can be a preformed layer that can be connected to and optionally removed from the surface of a substrate via an attachment arrangement (e.g., mechanical attachment arrangement, adhesive, primer, bonding agent, etc.). Although the non-stick release agent of the present invention is described as being applied to a food surface, it can be appreciated that the non-stick release agent can be applied to other surfaces on the cooking utensil (e.g., handle, outer side surface, outer bottom surface, lid, etc.); however, this is not required.

In another and/or alternative non-limiting aspect of the present invention, the primary mechanism by which the non-stick release agent is secured to the surface of the substrate of the cooking utensil is by use of a mechanical connection. In one non-limiting aspect of the invention, the non-stick release agent is only secured to the surface of the substrate of the cooking utensil by use of a mechanical connection. In another non-limiting aspect of the invention, the non-stick release agent is secured to the surface of the cooking utensil by a combination of a mechanical connection and an adhesive and/or primer coating. In one particular non-limiting arrangement, the non-stick release agent is only secured to the surface of the substrate of the cooking utensil by use of a mechanical connection, and no chemical, primer, or adhesive attachment arrangement is used. Such a mechanical connection arrangement results in reduced stresses being created on the non-stick release agent due to differential linear heat expansions between the substrate and the non-stick release agent, and/or the chemical or adhesive attachment arrangement and the substrate, and/or the chemical or adhesive attachment arrangement and the non-stick release agent.

In another and/or alternative non-limiting aspect of the present invention, the type of mechanical connection used to partially or fully secure the non-stick release agent to the surface of the substrate of the cooking utensil is non-limiting. In one non-limiting arrangement, the mechanical connection includes one or more surface structures on the outer surface of the substrate. The size, shape and/or configuration of the surface structures can be the same or different. The number, size, shape and/or configuration of the surface structures is non-limiting. The material used to form the plurality of surface structures is non-limiting. In another non-limiting arrangement, the mechanical connection includes one or more surface structures on the bottom surface and/or side surfaces of the non-stick release agent. The size, shape and/or configuration of the surface structures can be the same or different. The number, size, shape and/or configuration of the surface structures is non-limiting. The material used to form the plurality of surface structures is non-limiting. In another non-limiting arrangement, the mechanical connection includes one or more surface structures on the bottom surface and/or side surfaces of the non-stick release agent and on the outer surface of the substrate. The size, shape and/or configuration of the surface structures can be the same or different. The number, size, shape and/or configuration of the surface structures is non-limiting. The material used to form the plurality of surface structures is non-limiting.

In another and/or alternative non-limiting aspect of the present invention, the thermal expansion of the outer non-stick agent into the substrate can create its mechanical attachment or increase the strength of its mechanical attachment in addition to other means of mechanical attachment.

In another and/or alternative non-limiting aspect of the present invention, the non-stick release agent is secured to the surface of the substrate of the cooking utensil such that the non-stick release agent causes minimum interference with the heat transfer from the substrate of the cooking utensil to the food product that is positioned on the non-stick release agent. For example, silicone is known to be a very good insulating material. As such, if too thick of a silicone coating is used, the silicone will function as an insulator during the cooking or baking process which could interfere with the proper heating of a food product. This issue can especially arise when the cooking utensil is a frying pan, griddle plate, waffle iron, or the like where rapid heating of the food product can be required to properly bake or cook the food product. In one particular embodiment, the thickness of the non-stick release agent is at least about 0.02 inches. Generally, the thickness of the non-stick release agent is no more than about 0.6 inches. In one non-limiting arrangement, the thickness of the non-stick release agent is about 0.05-0.6 inches (and all values and ranges therebetween). In another non-limiting arrangement, when the non-stick release agent is silicone or primarily silicone, the thickness of the silicone is about 0.05-0.5 inches (and all ranges or values therebetween), and more typically about 0.1-0.35 inches; however, this is not required.

In another and/or alternative non-limiting aspect of the present invention, the non-stick release agent is a liquid silicone rubber (“LSR”) or high consistency silicone rubber that is applied to a substrate or a cooking utensil to form an improved cooking utensil.

In another and/or alternative non-limiting aspect of the present invention, the outer surface of the substrate of the cooking utensil includes a plurality of surface structures that are in the form of three-dimensional surface structures that are configured to mechanically capture and/or connect the non-stick release agent to the outer surface of the substrate. The plurality of surface structures are also configured to maintain close surface-to-surface contact between the outer surface of the substrate and the non-stick release agent through any heating cycle of the cooking utensil (e.g., cooking utensil at room temperature [i.e., 67-77° F.], warming of cooking utensil, cooking utensil at baking or cooking temperature, cooling of the cooking utensil after baking or cooking the food product, etc.). The plurality of surface structures are typically formed in the surface of the substrate, thus making the plurality of surface structures integral to the substrate; however, it can be appreciated that one or more of the surface structures can also or alternatively be connected to the surface of the substrate by one or more means (e.g., adhesive, weld, solder, melted connection, mechanical or friction fit connection, etc.); however, this is not required.

In another and/or alternative non-limiting aspect of the present invention, the non-stick release agent can include one or more fillers and/or reinforcement layers to alter (e.g., increase, decrease) the heat conductivity properties of the non-stick release agent and/or to increase the strength and/or durability of the non-stick release agent; however, this is not required. A non-limiting example of filler is metal particles, ceramic particles, polymer particles. When a filler is included in the non-stick release agent, the content of the filler is about 0.01-15% wt. % of the non-stick release agent (and all values and ranges therebetween). A non-limiting example of a reinforcement layer is a fiberglass mat, Kevlar® mat, etc. (e.g., woven or nonwoven mat) that is fully encapsulated in the non-stick release agent (e.g., a preformed silicon layer that encapsulates a fiberglass mat, etc.). When a reinforcement layer is included in the non-stick release agent, the content of the reinforcement layer is about 0.1-30% wt. % of the non-stick release agent (and all values and ranges therebetween).

In another and/or alternative non-limiting aspect of the present invention, a plurality of layers of non-stick release agent can be applied to the substrate; however, this is not required. When a plurality of layers of non-stick release agent are applied to the substrate, the different layers can have the same or different composition, and/or same or different layer thickness.

In another and/or alternative non-limiting aspect of the present invention, the plurality of surface structures on the substrate surface have one or more features (e.g., undercut features, etc.) that are used to mechanically secure the non-stick release agent to the substrate. The configuration of the surface structures on the substrate surface is selected so that the surface structures mechanically secure the non-stick release agent prior to, during, and after the heating of the cooking utensil. Generally, the material used to form the substrate has a different coefficient of thermal expansion than the non-stick release agent. As such, due to the slight expansion and deformation of the surface features on the substrate, and/or to the expansion and deformation of the non-stick release agent during the heating or the cooling of the substrate that constantly occurs due to the heating and/or baking of food products using the cooking utensil, the surface structures are configured to maintain a mechanical connection with the non-stick release agent during the complete heating and/or baking cycle. Additionally, the surface structures are configured to maintain contact with the non-stick release agent during the complete heating and/or baking cycle so that there is little or no interruption of heat transfer from the substrate to the non-stick release agent during the heating and/or baking of food products. In prior silicone-coated baking products, when the substrate of the cooking utensil was heated, the repeated expansion and contraction of the substrate cause the silicone coating to prematurely break down and partially release from the surface of the substrate. Once the silicone coating released from the substrate surface, an air gap typically formed between the substrate and the silicone coating. Such air gap resulted in a loss or reduction of heat transfer between the substrate and the silicone coating, thereby resulting in a non-uniform heating surface on the cooking utensil. Such non-uniform heating surface resulted in uneven cooking of the food product on the cooking utensil and/or added time required to properly heat and/or cook the food product on the cooking utensil. The surface features on the substrate surface in accordance with the present invention are configured to minimize or prevent a loss or reduction of heat transfer between the substrate and the non-stick release agent coating during the heating and/or baking of food products and to maintain a uniform heating surface during the heating and/or baking of food products. In one non-limiting embodiment, less than 5% (0-4.999% and all values and ranges therebetween) of the heating and/or baking surface of the cooking utensil that includes the mechanically connected non-stick release agent has a non-uniform heat transfer coefficient.

In another and/or alternative non-limiting aspect of the present invention, the plurality of surface structures on the substrate surface have a larger coefficient of thermal expansion than the non-stick release agent and are configured to cause the non-stick release agent to deform and/or release from a portion of the substrate during the heating and/or cooling of the substrate while still mechanically securing the non-stick release agent prior to, during, and after the heating of the cooking utensil. The plurality of surface structures on the substrate surface can be configured to also minimize or prevent a loss or reduction of heat transfer between the substrate and the non-stick release agent coating during the heating and/or baking of food products and to maintain a uniform heating surface during the heating and/or baking of food products when the non-stick release agent is caused to deform and/or release from a portion of the substrate during the heating and/or cooling of the substrate; however, this is not required. When the plurality of surface structures on the substrate surface that have a larger coefficient of thermal expansion than the non-stick release agent coating are heated, the plurality of surface structures will expand a greater amount than the non-stick release agent. Such expansion of the plurality of surface structures can result in slight changes in the shape of the plurality of surface structures which cause the non-stick release agent coating to deform and/or move off of a portion of the substrate (e.g., surface structure increases in height due to thermal expansion thereby causing the base of the non-stick release agent coating to be lifted off a portion of the substrate, etc.). The surface structures are configured to maintain a mechanical connection with the non-stick release agent even after the surface structures have expanded and/or deformed and the non-stick release agent has been deformed by the expansion and/or deformation of the surface structures. Furthermore, the surface structures are configured to minimize or prevent a loss or reduction of heat transfer between the substrate and the non-stick release agent coating during the expansion and/or deformation of the surface structures and the deformation of the non-stick release agent; however, this is not required. Also, the surface structures are configured to minimize or prevent the top surface of the non-stick release agent to deform, thereby maintaining a generally smooth baking surface of the non-stick release agent during the expansion and/or deformation of the surface structures and the deformation of the non-stick release agent; however, this is not required. Also, the surface structures are configured to minimize or prevent damage to the non-stick release agent during the expansion and/or deformation of the surface structures and the deformation of the non-stick release agent; however, this is not required.

In another and/or alternative non-limiting aspect of the present invention, the plurality of surface structures on the substrate surface have a smaller coefficient of thermal expansion than the non-stick release agent. During the heating of non-stick release agent, the non-stick release agent is caused to expand when heated to facilitate in securing the non-stick release agent to the substrate. The plurality of surface structures on the substrate surface can be configured to also minimize or prevent a loss or reduction of heat transfer between the substrate and the non-stick release agent coating during the heating and/or baking of food products and to maintain a uniform heating surface during the heating and/or baking of food products when the non-stick release agent is caused to deform and/or release from a portion of the substrate during the heating and/or cooling of the substrate; however, this is not required. A non-stick release agent such a silicone is a deformable material. Silicone has a larger coefficient of thermal expansion than an iron substrate. When the plurality of surface structures on the substrate surface that have a smaller coefficient of thermal expansion than the non-stick release agent (e.g., silicone) coating are heated, the non-stick release agent will expand a greater amount than the surface structure. By example, the thermal expansion coefficient of a substrate such as iron is less than 25 times the thermal expansion coefficient of silicone rubber. It is noted that by creating an outer silicone non-stick release layer that is smaller than an iron substrate by a range of 75-100% of the projected differential in thermal expansion (thus allowing a range of thermal expansion opportunity based on the projected heating or baking temperature range), the thermal expansion of the outer silicone non-stick coating can expand to create a very close surface-to-surface material contact between the iron substrate and the outer silicone release agent. It is further noted that this process (larger coefficient of thermal expansion of the silicone release agent to underlying substrate such as iron) creates an additional mechanical attachment alternative between the outer release agent and the substrate. Such expansion of the non-stick release agent can cause the non-stick release agent coating to deform and/or move off of a portion of the substrate (e.g., surface structure increases in height due to thermal expansion thereby causing the base of the non-stick release agent coating to be lifted off a portion of the substrate, etc.). The surface structures are configured to maintain a mechanical connection with the non-stick release agent even after the non-stick release agent has expanded and/or deformed. Furthermore, the surface structures are configured to minimize or prevent a loss or reduction of heat transfer between the substrate and the non-stick release agent coating during the expansion and/or deformation of the non-stick release agent; however, this is not required. Also, the surface structures are configured to minimize or prevent damage to the non-stick release agent during the expansion and/or deformation of the non-stick release agent; however, this is not required.

In another and/or alternative non-limiting aspect of the present invention, one or more of the surface structures are configured to extend into the coating of the non-stick release agent; however, this is not required. Such a configuration of the one or more surface structures can be used to promote heat transfer into the non-stick release agent such that the top surface of the one or more surface structures are close to the top surface (e.g., heating or baking surface) of the non-stick release agent; however, this is not required.

In another and/or alternative non-limiting aspect of the present invention, one or more of the surface structures are configured to be recessed in the substrate surface; however, this is not required. In such a configuration of the one or more surface structures, the coating of non-stick release agent extends into such recesses to form a mechanical connection with such recessed surface structures.

In another and/or alternative non-limiting aspect of the present invention, one or more of the surface structures can be applied to the substrate chemically and/or mechanically. For example, one or more of the surface structures can be applied to the substrate by investment casting; however, this is not required. In another example, one or more of the surface structures can be applied by connecting one or more of the surface structures by welding such surface structures to the surface of the substrate; however, this is not required. In another example, one or more of the surface structures can be formed in the substrate by drilling holes, stamping, etc. the substrate; however, this is not required. In another example, one or more of the surface structures can be formed in the substrate by chemical etching, laser cutting, water pressure etching, vapor deposition, micro-machining, etc. In another example, one or more of the surface structures can be formed in the substrate by coating the surface of the substrate with a material and optionally processing such coated material by one of the processed discussed above.

In another and/or alternative non-limiting aspect of the present invention, there is provided a method for forming a cooking utensil that has a coating of a non-stick release agent that is mechanically connected to the substrate of the cooking utensil to form a non-stick surface on the cooking utensil for use in the heating and/or baking of food products. The method includes the steps of: 1) providing a cooking utensil that is designed to heat and/or bake a food product, (e.g., frying pan, stock pot, griddle plate, waffle iron, pot, pan, cookie sheet, baking sheet, muffin pan, cake mold pan, ramekin, loaf pan, glass ware, ceramic bakeware, etc.), said cooking utensil has a heating and/or baking surface formed of a substrate material; 2) forming a plurality of surface structures in the top surface of the substrate that functions as the heating and/or baking surface of the cooking utensil; and 3) applying one or more coatings of a non-stick release agent (e.g., silicone, etc.) to the top surface of the substrate that functions as the heating and/or baking surface of the cooking utensil to form a non-stick surface on the heating and/or baking surface of the cooking utensil, wherein the non-stick release agent is mechanically connected to the top surface of the substrate, and wherein i) the non-stick release agent is formed of a different material from the surface structures and the top surface of the substrate, ii) the surface structures mechanically secure the non-stick release agent prior to, during, and after the heating of the cooking utensil, iii) the surface structures are configured to maintain contact with the non-stick release agent during the complete heating and/or baking cycle so that there is little or no interruption of heat transfer from the substrate to the non-stick release agent during the heating and/or cooling of the cooking utensil, iv) the non-stick release agent optionally has a lower heat transfer coefficient than the surface structures and the top surface of the substrate, v) the non-stick release agent optionally has a greater coefficient of thermal expansion than the surface structures and the top surface of the substrate, vi) the surface structures are configured to optionally minimize or prevent a loss or reduction of heat transfer between the substrate and the non-stick release agent coating during the heating and/or baking of food products and to maintain a uniform heating surface during the heating and/or baking of food products, vii) the surface structures are optionally configured to minimize or prevent the top surface of the non-stick release agent to deform to thereby maintain a generally smooth baking surface of the non-stick release agent during the expansion and/or deformation of the surface structures and the deformation of the non-stick release agent, viii) the surface structures are optionally configured to minimize or prevent damage to the non-stick release agent during the expansion and/or deformation of the surface structures and the deformation of the non-stick release agent, and ix) the plurality of surface structures mechanically secure the non-stick release agent to the substrate without use of a chemical connecting agent and/or adhesive; however, this is not required. The material used to form the substrate and/or one or more surface structures is non-limiting (e.g., aluminum, stainless steel, cast iron, copper, copper alloy, etc.). The number, size, shape, and/or configuration of the plurality of surface structures is non-limiting. In one non-limiting configuration, the size, shape, and configuration of the plurality of surface structures is generally the same; however, this is not required. When one or more surface structures extend a height above the surface of the substrate, the maximum height of the surface structures is generally no more than about 0.5 inches, and typically no more than about 0.4 inches; however, this is not required. Additionally or alternatively, when one or more surface structures extend into the surface of the substrate, the maximum depth of the surface structures is generally no more than about 0.2 inches, and typically no more than about 0.15 inches; however, this is not required. The spacing of the surface structures is such that adjacently positioned surface structures are no more than about 0.2 inches from one another, and typically no more than about 0.1 inches from one another; however, this is not required. When the surface structures are formed in the substrate, the substrate can be optionally prepared and/or cleaned by chemical (e.g., degreasing, etc.) and/or mechanical (e.g., abrasion, etc.) means such as, for example, by abrasively removing dirt and grime from the surface; however, this is not required. In one non-limiting configuration, the non-stick release agent is silicone that has a maximum thickness of no more than 0.5 inches, and typically no more than 0.3 inches. The silicone coating can be a single coating or formed of one or more coatings. The single coating or one or more coatings can optionally include one or more doping agents or additives to alter the properties of the silicone coating (e.g., increase or reduce heat transfer coefficient of the silicone coating, increase or reduce coefficient of thermal expansion of the silicone coating, increase or reduce the hardness and/or deformability of the silicone coating, increase the durability of the silicone coating, increase the heat resistance of the silicone coating, etc.). If more than one coating of silicone is applied to the substrate, the composition of the coatings of silicone can be the same or different. If multiple coatings of silicone are applied to the substrate, generally the top layer of silicone is silicone that is absent doped metals; however, this is not required. The silicone surface that is configured to contact a food surface is selected to be a food grade silicone. Generally, the plurality of surface structures are used to mechanically secure the non-stick release agent to the substrate without the use of any type of adhesive and/or chemical connecting agent; however, this is not required. The one or more coatings of non-stick release agent can be applied to the substrate by any number of means (spray coating, dipping, brush coating, compression molding, extrusion, injection molding, etc.). The non-stick release agent can be a preformed layer that can be applied to the substrate by an attachment means (e.g., mechanical attachment arrangement, adhesive, etc.). The non-stick release agent can include a reinforcement layer (e.g., fiberglass mat, etc.). If the non-stick release agent is applied to the substrate in liquid form, after the non-stick release agent is applied to the substrate, the non-stick release agent is generally allowed to cure; however, this is not required. During the optional curing process, the non-stick release agent is allowed time to harden and cure so as to form the desired mechanical connection with the substrate and form the desired material characteristics. In another and/or alternative non-limiting aspect of the present invention, there is provided a method for heating and/or cooking a food product using a cooking utensil having a coating of a non-stick release agent. The method comprises the steps of 1) providing a cooking utensil that is designed to heat and/or bake a food product and which cooking utensil has one or more coatings of a non-stick release agent to form a heating and/or baking surface that is a non-stick surface, and wherein the non-stick release agent is applied to the cooking utensil as described above, and wherein the substrate, surface structures and non-stick release agent have the size, shape, configuration, composition, properties and/or arrangement as described above; 2) placing a food product on the non-stick surface of the cooking utensil prior to, during, and/or after the cooking utensil has been heated to a desired temperature; 3) heating and/or baking the food product while in contact with the non-stick surface of the cooking utensil, and wherein i) a plurality of surface structures optionally change in shape due to heat expansion during the heating of the cooking utensil, ii) a plurality of surface structures optionally cause the non-stick release agent coating to deform and/or move off of a portion of the substrate, iii) the surface structures maintain a mechanical connection with the non-stick release agent even after the surface structures have optionally expanded and/or deformed and the non-stick release agent have optionally been deformed by the optional expansion and/or deformation of the surface structures, iv) the surface structures optionally minimize or prevent a loss or reduction of heat transfer between the substrate and the non-stick release agent coating during the optional expansion and/or deformation of the surface structures and the optional deformation of the non-stick release agent; v) the surface structures optionally minimize or prevent the top surface of the non-stick release agent to deform to thereby maintain a generally smooth baking surface of the non-stick release agent during the optional expansion and/or deformation of the surface structures and the optional deformation of the non-stick release agent; and vi) the surface structures minimize or prevent damage to the non-stick release agent during the optional expansion and/or deformation of the surface structures and the optional deformation of the non-stick release agent; and 4) removing the food product from the non-stick surface of the cooking utensil prior to or after the food product has been heated, baked and/or cooled, wherein the food product does not stick to the non-stick surface of the cooking utensil, and wherein the food product is not damaged when removed from the non-stick surface of the cooking utensil.

In another and/or alternative non-limiting aspect of the present invention, there is provided a method for re-coating a cooking utensil with a release agent. In one non-limiting arrangement, the method comprises 1) providing a used cooking utensil having a worn or damaged non-stick surface, and wherein the cooking utensil prior to being used was designed to heat and/or bake a food product and which cooking utensil had one or more coatings of a non-stick release agent to form a heating and/or baking surface that is a non-stick surface, and wherein the non-stick release agent was applied to the cooking utensil as described above, and wherein the substrate, surface structures and non-stick release agent have the size, shape, configuration, composition, properties and/or arrangement as described above; 2) removing the worn or damaged non-stick surface from the substrate and surface structures of the cooking utensil by any form of physical removal, such as pulling by hand or by a tool (which can typically be easily accomplished in the case of a mechanical attachment) or by the use of a solvent (e.g., isopropyl alcohol (IPA), xylene, etc.) removal method and/or by use of silicone digesters or emulsifiers, heat (e.g., burn-off (600+° C.), etc.) or other physical removal; 3) optionally cleaning the substrate surface after the worn or damaged non-stick surface has been removed from the substrate and surface structures of the cooking utensil; 4) applying one or more coatings of a non-stick release agent (e.g., silicone, etc.) to the surface of the substrate that previous contained the worn or damaged non-stick surface to thereby form a new non-stick surface on the cooking utensil, wherein i) the non-stick release agent is optionally the same non-stick release agent that was removed from the surface of the substrate, ii) the newly re-coated non-stick release agent is mechanically connected to the top surface of the substrate, iii) the non-stick release agent is optionally formed of a different material from the surface structures and the top surface of the substrate, iv) the surface structures mechanically secure the non-stick release agent prior to, during, and after the heating of the cooking utensil, v) the surface structures are optionally configured to maintain contact with the non-stick release agent during the complete heating and/or baking cycle so that there is little or no interruption of heat transfer from the substrate to the non-stick release agent during the heating and/or cooling of the cooking utensil, vi) the non-stick release agent optionally has a lower heat transfer coefficient than the surface structures and the top surface of the substrate, vii) the non-stick release agent optionally has a greater coefficient of thermal expansion than the surface structures and the top surface of the substrate, viii) the surface structures are configured to optionally minimize or prevent a loss or reduction of heat transfer between the substrate and the non-stick release agent coating during the heating and/or baking of food products and to maintain a uniform heating surface during the heating and/or baking of food products, ix) the surface structures are optionally configured to minimize or prevent the top surface of the non-stick release agent to deform to thereby maintain a generally smooth baking surface of the non-stick release agent during the expansion and/or deformation of the surface structures and the deformation of the non-stick release agent, x) the surface structures are optionally configured to minimize or prevent damage to the non-stick release agent during the expansion and/or deformation of the surface structures and the deformation of the non-stick release agent, and xi) the plurality of surface structures mechanically secure the non-stick release agent to the substrate without use of a chemical connecting agent and/or adhesive. In one non-limiting configuration, the non-stick release agent is silicone that has a maximum thickness of no more than 0.5 inches, and typically no more than 0.3 inches. The silicone coating can be a single coating or formed of one or more coatings. The single coating or one or more coatings of the silicone coating can optionally include one or more doping agents or additives to alter the properties of the silicone coating (e.g., increase or reduce heat transfer coefficient of the silicone coating, increase or reduce coefficient of thermal expansion of the silicone coating, increase or reduce the hardness and/or deformability of the silicone coating, increase the durability of the silicone coating, increase the heat resistance of the silicone coating, etc.). If more than one coating of silicone is applied to the substrate, the composition of the coatings of silicone can be the same or different. If multiple coatings of silicone are applied to the substrate, generally the top layer of silicone is absent metal additions and/or any other type of addition; however, this is not required. The silicone surface that is configured to contact a food surface is selected to be a food-grade silicone. Generally, the plurality of surface structures are used to mechanically secure the non-stick release agent to the substrate with use of any type of adhesive and/or chemical connecting agent; however, this is not required. The one or more coatings of non-stick release agent can be applied to the substrate by any number of means (spray coating, dipping, brush coating, compression molding, extrusion, injection molding, or by simply pushing, pressing or stretching by hand, etc.). After the non-stick release agent is applied to the substrate, the non-stick release agent is generally allowed to cure; however, this is not required. It is also possible that non-stick release agent can be cured in advance at the time it is formed, such as is the case with liquid silicone rubber, or elastomeric silicone, and then pressed pushed or stretched into or onto the substrate. During the optional curing process, the non-stick release agent is allowed time to harden and cure so as to form the desired mechanical connection with the substrate.

One non-limiting object of the present invention is the provision of an improved cooking utensil having a non-stick surface.

Another and/or alternative non-limiting object of the present invention is the provision of an improved cooking utensil having a non-stick surface that includes one or more coatings of a non-stick release agent.

Another and/or alternative non-limiting object of the present invention is the provision of an improved cooking utensil having one or more coatings of a non-stick release agent that is mechanically connected to the substrate of the cooking utensil, and which mechanical connection can be the only connection arrangement used to secure the one or more coatings of a non-stick release agent to the substrate of the cooking utensil.

Another and/or alternative non-limiting object of the present invention is the provision of an improved cooking utensil having improved life of the non-stick release agent on the substrate of the cooking utensil.

Another and/or alternative non-limiting object of the present invention is the provision of an improved cooking utensil which inhibits the permanent separation of the non-stick release agent from the substrate of the cooking utensil.

Another and/or alternative non-limiting object of the present invention is the provision of an improved cooking utensil that uses a mechanical connection arrangement that optionally promotes the heat transfer between the substrate of the cooking utensil and the non-stick release agent.

Another and/or alternative non-limiting object of the present invention is the provision of an improved cooking utensil that uses a mechanical connection arrangement that optionally maintains close surface-to-surface contact between the substrate of the cooking utensil and the non-stick release agent.

Another and/or alternative non-limiting object of the present invention is the provision of an improved cooking utensil that optionally reduces stresses being created on the non-stick release agent due to differential liner heat expansions between the substrate and the non-stick release agent, thus increasing the useable life of the non-stick release agent on the substrate of the cooking utensil.

Another and/or alternative non-limiting object of the present invention is the provision of an improved cooking utensil wherein the type of mechanical connection used to partially or fully secure the non-stick release agent to the surface of the substrate of the cooking utensil includes one or more surface structures on the outer surface of the substrate.

Another and/or alternative non-limiting object of the present invention is the provision of an improved cooking utensil wherein the non-stick release agent is secured to the surface of the substrate of the cooking utensil such that the non-stick release agent optionally causes minimum interference with the heat transfer from the substrate of the cooking utensil to the food product that is positioned on the non-stick release agent.

Another and/or alternative non-limiting object of the present invention is the provision of an improved cooking utensil wherein the non-stick release agent optionally includes one or more layers or coatings of silicone or primarily silicone.

Another and/or alternative non-limiting object of the present invention is the provision of an improved cooking utensil wherein the non-stick release agent optionally is a liquid silicone rubber (“LSR”) or high consistency silicone rubber.

Another and/or alternative non-limiting object of the present invention is the provision of an improved cooking utensil wherein the outer surface of the substrate of the cooking utensil includes a plurality of surface structures that are configured to mechanically capture and/or connect the non-stick release agent to the outer surface of the substrate.

Another and/or alternative non-limiting object of the present invention is the provision of an improved cooking utensil wherein the outer surface of the substrate of the cooking utensil includes a plurality of surface structures that are configured to maintain close surface-to-surface contact between the outer surface of the substrate and the non-stick release agent through any heating cycle of the cooking utensil.

Another and/or alternative non-limiting object of the present invention is the provision of an improved cooking utensil wherein the outer surface of the substrate of the cooking utensil includes a plurality of surface structures that can optionally be formed in the surface of the substrate, thus making the plurality of surface structures integral to the substrate.

Another and/or alternative non-limiting object of the present invention is the provision of an improved cooking utensil wherein the outer surface of the substrate of the cooking utensil includes a plurality of surface structures that can optionally be connected to the surface of the substrate by one or more means (e.g., adhesive, weld, solder, melted connection, mechanical connection, friction fit connection, etc.).

Another and/or alternative non-limiting object of the present invention is the provision of an improved cooking utensil wherein the non-stick release agent can optionally include one or more fillers to alter (e.g., increase, decrease) the heat conductivity properties of the non-stick release agent.

Another and/or alternative non-limiting object of the present invention is the provision of an improved cooking utensil wherein the outer surface of the substrate of the cooking utensil optionally includes a plurality of layers of non-stick release agent that can have the same or different composition, and/or same or different layer thickness.

Another and/or alternative non-limiting object of the present invention is the provision of an improved cooking utensil wherein the non-stick release agent that is applied to the outer surface of the substrate of the cooking utensil can be optionally polished to form a substantially smooth, glossy, baking surface of the non-stick release agent.

Another and/or alternative non-limiting object of the present invention is the provision of an improved cooking utensil wherein the outer surface of the substrate of the cooking utensil includes a plurality of surface structures that optionally have a smaller coefficient of thermal expansion than the non-stick release agent.

Another and/or alternative non-limiting object of the present invention is the provision of an improved cooking utensil wherein the outer surface of the substrate of the cooking utensil includes a plurality of surface structures that are optionally configured to maintain contact with the non-stick release agent during the complete heating and/or baking cycle so that there is little or no interruption of heat transfer from the substrate to the non-stick release agent during the heating and/or baking of food products.

Another and/or alternative non-limiting object of the present invention is the provision of an improved cooking utensil wherein the outer surface of the substrate of the cooking utensil includes a plurality of surface structures that optionally have a smaller coefficient of thermal expansion than the non-stick release agent and are optionally configured to cause the non-stick release agent to deform and/or release from a portion of the substrate during the heating and/or cooling of the substrate while still mechanically securing the non-stick release agent prior to, during, and after the heating of the cooking utensil.

Another and/or alternative non-limiting object of the present invention is the provision of an improved cooking utensil wherein the outer surface of the substrate of the cooking utensil includes a plurality of surface structures that are optionally configured to also minimize or prevent a loss or reduction of heat transfer between the substrate and the non-stick release agent coating during the heating and/or baking of food products and to optionally maintain a uniform heating surface during the heating and/or baking of food products when the non-stick release agent is caused to deform and/or release from a portion of the substrate during the heating and/or cooling of the substrate.

Another and/or alternative non-limiting object of the present invention is the provision of an improved cooking utensil wherein the non-stick release agent is optionally a deformable material.

Another and/or alternative non-limiting object of the present invention is the provision of an improved cooking utensil wherein the outer surface of the substrate of the cooking utensil includes a plurality of surface structures that are optionally configured to minimize or prevent the top surface of the non-stick release agent to deform to thereby maintain a generally smooth baking surface of the non-stick release agent during the expansion and/or deformation of the surface structures and the deformation of the non-stick release agent.

Another and/or alternative non-limiting object of the present invention is the provision of an improved cooking utensil wherein the outer surface of the substrate of the cooking utensil includes a plurality of surface structures that are optionally configured to minimize or prevent damage to the non-stick release agent during the expansion and/or deformation of the surface structures and the deformation of the non-stick release agent.

Another and/or alternative non-limiting object of the present invention is the provision of an improved cooking utensil wherein the outer surface of the substrate of the cooking utensil includes a plurality of surface structures that are optionally configured to mechanically connect the non-stick release agent to the top surface of the substrate without need of a chemical connection agent or adhesive.

Another and/or alternative non-limiting object of the present invention is the provision of an improved cooking utensil wherein the outer surface of the substrate of the cooking utensil includes a plurality of surface structures that are optionally configured to extend into the coating of the non-stick release agent.

Another and/or alternative non-limiting object of the present invention is the provision of an improved cooking utensil wherein the outer surface of the substrate of the cooking utensil includes a plurality of surface structures that are optionally configured to be recessed in the substrate surface and the coating of non-stick release agent extends into such recesses to form a mechanical connection with such recessed surface structures.

Another and/or alternative non-limiting object of the present invention is the provision of an improved cooking utensil wherein the outer surface of the substrate of the cooking utensil includes a plurality of surface structures that are optionally applied to the substrate by chemical means and/or mechanical means.

Another and/or alternative non-limiting object of the present invention is the provision of an improved cooking utensil wherein the substrate and/or one or more surface structures is optionally formed of aluminum, stainless steel, cast iron, copper, copper alloy, etc.

Another and/or alternative non-limiting object of the present invention is the provision of an improved cooking utensil wherein the outer surface of the substrate of the cooking utensil includes a plurality of surface structures wherein the number, size, shape, and/or configuration of the plurality of surface structures is non-limiting.

Another and/or alternative non-limiting object of the present invention is the provision of an improved cooking utensil wherein the outer surface of the substrate of the cooking utensil includes a plurality of surface structures wherein the number, size, shape, and/or configuration of the plurality of surface structures is generally the same.

Another and/or alternative non-limiting object of the present invention is the provision of an improved cooking utensil wherein the coating of the non-stick release agent can optionally include one or more doping agents or additives to alter the properties of the silicone coating (e.g., increase or reduce heat transfer coefficient of the coating, increase or reduce coefficient of thermal expansion of the coating, increase or reduce the hardness and/or deformability of the coating, increase the durability of the coating, increase the heat resistance of the coating, etc.).

Another and/or alternative non-limiting object of the present invention is the provision of an improved cooking utensil wherein the coating of the non-stick release agent can be applied to the substrate by any number of means (pushing, pressing, stretching by hand or spray coating, dipping, brush coating, vapor deposition, compression molding, extrusion, injection molding, etc.).

Another and/or alternative non-limiting object of the present invention is the provision of a method for forming an improved cooking utensil that includes the steps of: 1) providing a cooking utensil that is designed to heat and/or bake a food product; 2) forming a plurality of surface structures in the top surface of the substrate; 3) applying one or more coatings of a non-stick release agent to the top surface of the substrate, wherein the non-stick release agent is mechanically connected to the top surface of the substrate, and wherein i) the non-stick release agent is optionally formed of a different material from the surface structures and the top surface of the substrate, ii) the surface structures mechanically secure the non-stick release agent prior to, during, and after the heating of the cooking utensil, iii) the surface structures are optionally configured to maintain contact with the non-stick release agent during the complete heating and/or baking cycle so that there is little or no interruption of heat transfer from the substrate to the non-stick release agent during the heating and/or cooling of the cooking utensil, iv) the non-stick release agent optionally has a lower heat transfer coefficient than the surface structures and the top surface of the substrate, v) the non-stick release agent optionally has a greater coefficient of thermal expansion than the surface structures and the top surface of the substrate, vi) the surface structures are configured to optionally minimize or prevent a loss or reduction of heat transfer between the substrate and the non-stick release agent coating during the heating and/or baking of food products and to maintain a uniform heating surface during the heating and/or baking of food products, vii) the surface structures are optionally configured to minimize or prevent the top surface of the non-stick release agent to deform to thereby maintain a generally smooth baking surface of the non-stick release agent during the expansion and/or deformation of the surface structures and the deformation of the non-stick release agent, viii) the surface structures are optionally configured to minimize or prevent damage to the non-stick release agent during the expansion and/or deformation of the surface structures and the deformation of the non-stick release agent, and ix) the plurality of surface structures mechanically secure the non-stick release agent to the substrate without use of a chemical connecting agent and/or adhesive.

Another and/or alternative non-limiting object of the present invention is the provision of a method for heating and/or cooking a food product using a cooking utensil having a coating of a non-stick release agent that comprises the steps of 1) providing a cooking utensil that is designed to heat and/or bake a food product and which cooking utensil has one or more coatings of a non-stick release agent to form a heating and/or baking surface that is a non-stick surface, and wherein the non-stick release agent is applied to the cooking utensil as described above, and wherein the substrate, surface structures and non-stick release agent have the size, shape, configuration, composition, properties and/or arrangement as described above; 2) placing a food product on the non-stick surface of the cooking utensil prior to, during, and/or after the cooking utensil has been heated to a desired temperature; 3) heating and/or baking the food product while in contact with the non-stick surface of the cooking utensil, and wherein i) a plurality of surface structures optionally change in shape due to heat expansion step during the heating of the cooking utensil, ii) a plurality of surface structures optionally cause the non-stick release agent coating to deform and/or move off of a portion of the substrate, iii) the surface structures maintain a mechanical connection with the non-stick release agent even after the surface structures have optionally expanded and/or deformed and the non-stick release agent has optionally been deformed by the optional expansion and/or deformation of the surface structures, iv) the surface structures optionally minimize or prevent a loss or reduction of heat transfer between the substrate and the non-stick release agent coating during the optional expansion and/or deformation of the surface structures and the optional deformation of the non-stick release agent; v) the surface structures optionally minimize or prevent the top surface of the non-stick release agent to deform to thereby maintain a generally smooth baking surface of the non-stick release agent during the optional expansion and/or deformation of the surface structures and the optional deformation of the non-stick release agent; and vi)the surface structures minimize or prevent damage to the non-stick release agent during the optional expansion and/or deformation of the surface structures and the optional deformation of the non-stick release agent; and 4) removing the food product from the non-stick surface of the cooking utensil prior to or after the food product has been heated, baked and/or cooled, wherein the food product does not stick to the non-stick surface of the cooking utensil, and wherein the food product is optionally not damaged when removed from the non-stick surface of the cooking utensil.

Another and/or alternative non-limiting object of the present invention is the provision of a method for re-coating a cooking utensil with a release agent that comprises the steps of 1) providing a used cooking utensil having a worn or damaged non-stick surface, and wherein the cooking utensil prior to being used was designed to heat and/or bake a food product and which cooking utensil had one or more coatings of a non-stick release agent to form a heating and/or baking surface that is a non-stick surface, and wherein the non-stick release agent was applied to the cooking utensil as described above, and wherein the substrate, surface structures and non-stick release agent have the size, shape, configuration, composition, properties and/or arrangement as described above; 2) removing the worn or damaged non-stick surface from the substrate and surface structures of the cooking utensil by hand or common tool, or by use of a solvent removal method and/or by use of silicone digesters or emulsifiers or heat (e.g., burn-off (600+° C.), etc.); 3) optionally cleaning the substrate surface after the worn or damaged non-stick surface has been removed from the substrate and surface structures of the cooking utensil; 4) applying one or more coatings of a non-stick release agent to the surface of the substrate that previously contained the worn or damaged non-stick surface to thereby form a new non-stick surface on the cooking utensil, wherein i) the non-stick release agent is optionally the same non-stick release agent that was removed from the surface of the substrate, ii) the newly recoated non-stick release agent is mechanically connected to the top surface of the substrate, iii) the non-stick release agent is optionally formed of a different material from the surface structures and the top surface of the substrate, iv) the surface structures mechanically secure the non-stick release agent prior to, during, and after the heating of the cooking utensil, v) the surface structures are optionally configured to maintain contact with the non-stick release agent during the complete heating and/or baking cycle so that there is little or no interruption of heat transfer from the substrate to the non-stick release agent during the heating and/or cooling of the cooking utensil, vi) the non-stick release agent optionally has a lower heat transfer coefficient than the surface structures and the top surface of the substrate, vii) the non-stick release agent optionally has a greater coefficient of thermal expansion than the surface structures and the top surface of the substrate, viii) the surface structures are configured to optionally minimize or prevent a loss or reduction of heat transfer between the substrate and the non-stick release agent coating during the heating and/or baking of food products and to maintain a uniform heating surface during the heating and/or baking of food products, ix) the surface structures are optionally configured to minimize or prevent the top surface of the non-stick release agent to deform to thereby maintain a generally flat top surface of the non-stick release agent during the expansion and/or deformation of the surface structures and the deformation of the non-stick release agent, x) the surface structures are optionally configured to minimize or prevent damage to the non-stick release agent during the expansion and/or deformation of the surface structures and the deformation of the non-stick release agent, and xi) the plurality of surface structures mechanically secure the non-stick release agent to the substrate without use of a chemical connecting agent and/or adhesive.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various non-limiting embodiments that the invention may take in physical form and in certain parts and arrangement of parts wherein:

FIG. 1 is an illustration of the prior art arrangement for applying a silicone layer to the surface of a substrate of a cooking utensil (which would typically be a spray resin) and an illustration of one non-limiting embodiment of the present invention that uses a plurality of surface structures to mechanically connect the silicone layer (which might typically be a liquid silicone rubber or elastomeric silicone) to the surface of a substrate of a cooking utensil and a comparison of the temperature profiles of the top surface of the silicone coating during the heating of the substrate;

FIG. 2 is an illustration showing a method of mechanically applying a plurality of surface structures to a top surface of a substrate of a cooking utensil in accordance with one non-limiting aspect of the present invention;

FIG. 3 is a cross-sectional illustration of another non-limiting configuration of a plurality of surface structures on a top surface of a substrate that extend upwardly from the top surface of the substrate and a layer of silicone coated on the surface structures in accordance with a non-limiting aspect of the present invention;

FIG. 4 is a cross-sectional illustration of another non-limiting configuration of a plurality of surface structures on a top surface of a substrate that are recessed in the top surface of the substrate and a layer of silicone coated on the surface structures in accordance with a non-limiting aspect of the present invention;

FIG. 5 is a cross-sectional illustration of another non-limiting configuration of a plurality of surface structures on a top surface of a substrate that are recessed in the top surface of the substrate and a layer of silicone coated on the surface structures in accordance with a non-limiting aspect of the present invention;

FIG. 6 is a cross-sectional illustration of another non-limiting configuration of a plurality of surface structures on a top surface of a substrate that extend upwardly from the top surface of the substrate and a layer of silicone coated on the surface structures in accordance with a non-limiting aspect of the present invention;

FIG. 7 is a cross-sectional illustration of another non-limiting configuration of a plurality of surface structures on a top surface of a substrate that extend upwardly from the top surface of the substrate and a layer of silicone coated on the surface structures in accordance with a non-limiting aspect of the present invention; and,

FIG. 8 is a cross-sectional illustration of another non-limiting configuration of a plurality of surface structures on a top surface of a substrate that are recessed in the top surface of the substrate and a layer of silicone coated on the surface structures in accordance with a non-limiting aspect of the present invention.

### DETAILED DESCRIPTION OF THE NON-LIMITING EMBODIMENTS

The present invention is directed to cooking utensils having a non-stick release agent, and in particular to cooking utensils having a non-stick release agent that is mechanically connected to the surface the cooking utensil. One non-limiting non-stick release agent that can be used in the present invention is silicone. Silicone is a food safe material that forms a low-stick or non-stick surface when exposed to many different types of food products. For example, when heating or baking bakery products, the silicone surface forms nearly a non-stick surface with the bakery products. Silicone also does not degrade below temperatures of about 500-600° F., thus can be used to heat and cook many types of food products. The silicone coating can be silicone or a silicone resin or can be silicone that includes one or more additives.

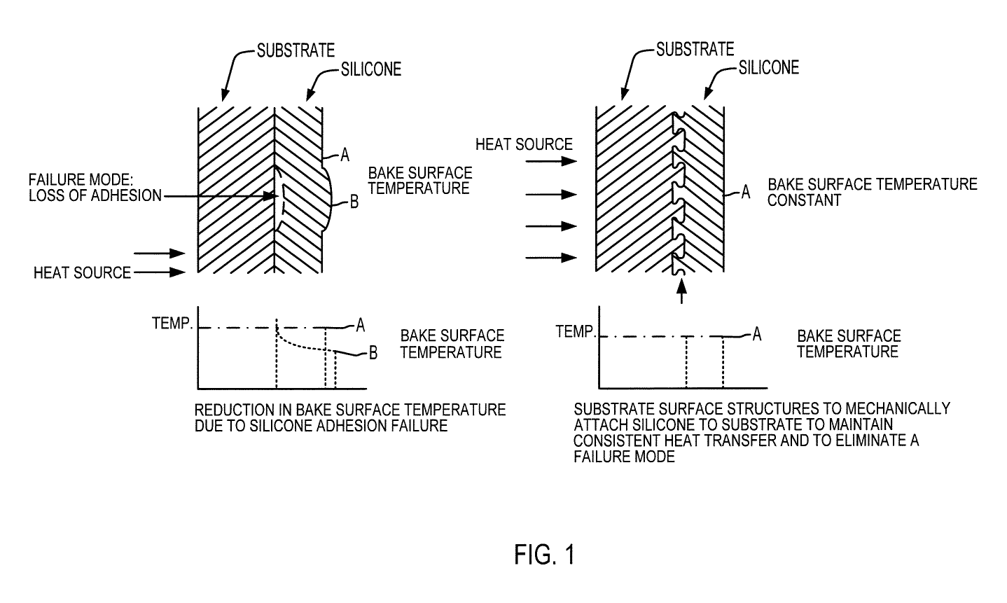

Although silicone is known to form a non-stick cooking surface for cooking utensils, silicone coatings present several challenges that have inhibited wide adoption of such coatings on cooking utensils. Silicone is known to be a compound that has good insulating properties. As such, silicon coatings that are too thick can interfere with the proper baking of a food product. Silicone also has a greater heat expansion coefficient than most substrates upon which the silicone is coated thereon. As such, during repeated heating and cooling of the substrate of the cooking utensil, the smaller expansion and resulting contraction of the substrate as compared to the silicone coating causes the silicone coating to release from the surface of the substrate and further the substrate loses its non-stick surface. The loss of adhesion between the silicone coating and the substrate results in air pockets forming between the silicone coating and the substrate that interfere with the uniform heat transfer from the substrate to the silicone coating and to the food product being heated or baked on the top surface of the silicone layer. As illustrated in FIG. 1, the temperature profile on the left side illustrates the significant temperature decrease between the substrate temperature and the surface of the silicone coating where the silicone layer has separated from the substrate as illustrated in the left side illustration in FIG. 1. This of course has been the end result of the use of sprayed adhesive resin-based silicone coatings.

The surface structures in accordance with the present invention creates a mechanical connection between the substrate and the silicone coating that minimizes the temperature decrease between the temperature of the substrate and the top surface of the silicone coating. One non-limiting surface structure arrangement is illustrated in the right side illustration of FIG. 1 and the temperature profile is represented below such illustration. As is evident between the two temperature profiles set forth in FIG. 1, the mechanical connection created by the plurality of surface structures on the substrate surface minimizes the loss of temperature between the substrate and the top surface of the silicone coating.

Generally, for cooking utensils that are used to cook, bake or heat a food product, the substrate is typically formed of a high heat conducting material (e.g., metal, etc.); however, this is not required.

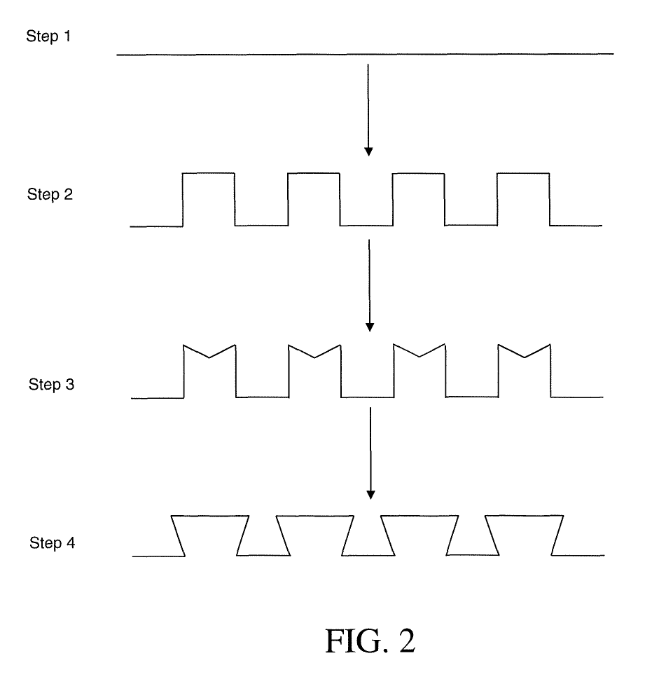

The shape and configuration of the surface structures are non-limiting. Likewise, the method by which the surface structures are formed on the substrate surface is non-limiting. FIG. 2 is an illustration of a non-limiting method for mechanically forming a plurality of surface structures on the top surface of a substrate in accordance with one non-limiting aspect of the present invention. Initially, a substrate (i.e., part of the cooking surface of a cooking utensil) is provided. The substrate can be successively machine-stamped, thereby providing a plurality of undercut features on the cooking surface of the substrate; however, this is not required.

Step 1 of FIG. 2 illustrates a top surface of a substrate prior to beginning the process of forming a plurality of surface structures in the substrate surface. The top surface of the substrate is illustrated as being generally flat; however, this is not required.

Step 2 of FIG. 2 illustrates the top surface of the substrate being subjected to a stamping process wherein a plurality of indents have been formed in the substrate surface.

Step 3 of FIG. 2 illustrates the top of the indents that were formed in Step 2 being further subjected to a second stamping process wherein a V-shaped groove is formed in the top of the indents.

Step 4 of FIG. 2 illustrates the top of the indents that were formed in Step 3 being further subjected to a third stamping process wherein the tops of the indents are flattened thereby forming a plurality of surface structures on the substrate surface wherein a top portion of the surface structure has a greater cross-sectional area than a portion of the surface structure that is located below the top of the surface structure. As such, an undercut is formed under the top of the surface structure that can be used to mechanically secure a layer of silicone coating that has been applied to the substrate and the surface structures on the substrate. Generally, when the silicone layer is applied to the substrate and the surface structures on the substrate, the thickness of the silicone layer that is located above the top surface of the surface structures is generally at least about 0.05 inches and typically no more than about 0.25 inches; however, this is not required. The method by which the silicone coating is applied to the substrate and the surface structures on the substrate is non-limiting. In one non-limiting application method, the silicone is spray coated on to the substrate and the surface structures on the substrate.

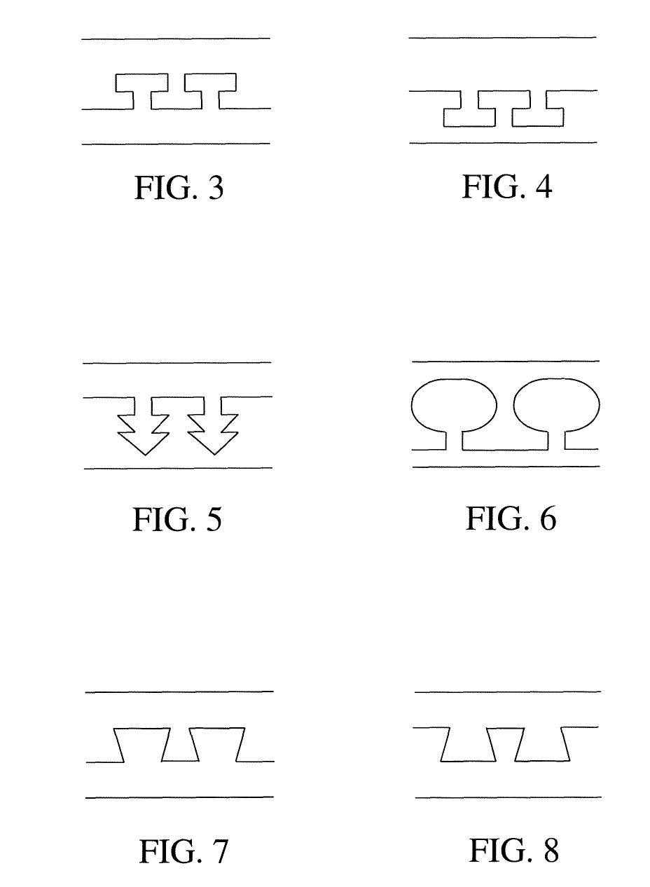

FIGS. 3-8 are cross-sectional illustrations of other non-limiting surface structure configurations that can be used in accordance with the present invention. The top line in each of the figures represents the top surface of the silicone coating. The bottom line in each of the figures represents the base of the substrate. The surface structures (as illustrated in FIGS. 2-8) are configured provide a sufficient mechanical connection between the substrate that the silicone coating such that the silicone coating does not release from the substrate and surface structures during the heating and cooling of the substrate.

FIGS. 3, 6 and 7 illustrate surface structures in the substrate surface that extend upwardly from the substrate surface and extend into a portion of the silicone coating. As illustrated in the figures, the surface structures do not extend fully through the silicone coating.

FIGS. 4, 5 and 8 illustrate surface structures in the substrate surface that are recessed into the top surface of the substrate.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

What is claimed:

1. A cooking utensil comprising:
a substrate;
one or more surface structures on an outer surface of the substrate; and,
a non-stick release agent mechanically connected to the one or one or more surface structures, a top surface of the non-stick release agent forming a non-stick surface on said cooking utensil.

2. A cooking utensil comprising:
a substrate; and,
a non-stick release agent that is mechanically connected to the substrate, the substrate and/or the non-stick release agent includes one or one or more surface structures that facilitate in mechanically connecting the non-stick release agent to the substrate, a top surface of the non-stick release agent forming a non-stick surface on said cooking utensil.

3. A method for heating or baking a food product by use of a cooking utensil comprising:
providing a cooking utensil, said cooking utensil comprising:
a substrate; and,
a non-stick release agent that is mechanically connected to the substrate, the substrate and/or the non-stick release agent includes one or one or more surface structures that facilitate in mechanically connecting the non-stick release agent to the substrate, a top surface of the non-stick release agent forming a non-stick surface on said cooking utensil;
placing the food product in contact with the non-stick surface on the cooking utensil;
heating or baking the food products while the food product is in contact with the non-stick surface on the cooking utensil; and,
removing the food product from contact with the non-stick surface on the cooking utensil.

4. A method for mechanically securing a non-stick release agent to a substrate of a cooking utensil, the method comprising:
providing a cooking utensil that has the substrate;
forming a plurality of surface structures in the substrate; and,
applying the non-stick release agent to the substrate that includes the plurality of surface structures, said plurality of surface structures forming a mechanical connection with the non-stick release agent.

5. A method for mechanically securing a non-stick release agent to a substrate of a cooking utensil, the method comprising:
providing a cooking utensil that has the substrate;
providing a non-stick release agent, a top surface of the non-stick release agent forming a non-stick surface on said cooking utensil;
mechanically connecting the non-stick release agent to the substrate, the substrate and/or the non-stick release agent includes one or one or more surface structures that facilitate in mechanically connecting the non-stick release agent to the substrate.

6. A method for re-coating a cooking utensil with a non-stick release agent, the method comprising:
providing a cooking utensil having a worn and/or damaged coating of a non-stick release agent;
removing the worn and/or damaged non-stick release agent from a substrate of the cooking utensil without damaging the substrate or any surface structures on the substrate;
providing an unused non-stick release agent, a top surface of the non-stick release agent forming a non-stick surface on said cooking utensil; and,
mechanically connecting the non-stick release agent to the substrate, the substrate and/or the non-stick release agent includes one or one or more surface structures that facilitate in mechanically connecting the non-stick release agent to the substrate.
